(19) United States
(12) Patent Application Publication
(10) Pub. No.: US 2013/0087107 A1
(43) Pub. Date: Apr. 11, 2013

(54) Steam Generation Device and Household Electric Steam Box

(71) Applicants: Bei Zhang, Shenzhen (CN); Tianliang Wang, Shenzhen (CN); Faxi Hang, Shenzhen (CN); Caihe Feng, Shenzhen (CN)

(72) Inventors: Bei Zhang, Shenzhen (CN); Tianliang Wang, Shenzhen (CN); Faxi Hang, Shenzhen (CN); Caihe Feng, Shenzhen (CN)

(73) Assignee: CRASTAL TECHNOLOGY (SHENZHEN) CO., LTD., Shenzhen, Guangdong (CN)

(21) Appl. No.: 13/704,988

(22) PCT Filed: May 23, 2011
(86) PCT No.: PCT/CN2011/074541

§ 371 Date: Dec. 18, 2012

(30) Foreign Application Priority Data
Aug. 25, 2010 (CN) 201010262658.1

(51) Int. Cl. F16T 1/00

(52) U.S. Cl. CPC F16T 1/00
USPC 122/491

(57) ABSTRACT

A steam generation device includes a water tank, a steam-water separating device including a sealing cover and a base assembly, a guiding valve, at least one heat generating tube, wherein said water tank has a water returning inlet while said base assembly has a water returning tube connected to said water returning inlet, wherein said base assembly has a flat bottom wall and an inclined bottom wall formed at a bottom side of said base assembly at a position near said water returning tube, wherein said steam-water separating device has an air outlet, wherein said water tank further has a water outlet connected to said guiding valve through passage IV, wherein said steam-water separating device and said passage IV are connected with each other. The present invention also provides a household steaming device which is safe, energy efficient and water efficient.

### BACKGROUND OF THE PRESENT INVENTION

1. Field of Invention

The present invention relates to a steam generation device and a household electrical steaming box.

2. Description of Related Arts

There exist many household electrical steaming devices as conventional technology. For example, the inventor of the present invention applied for a Chinese patent having a filing date of Feb. 12, 2010 and an application number of 201010114441.6 [the title of that patent application is household steaming box]. This patent application discloses a household steaming box which is highly efficient in steaming, and extremely simple in assembling. However, the household steaming box also possesses a number of disadvantages:

1. When a water storing tank has a relatively small water outlet (that is, when the flow rate of the water flowing from the water storing tank to a water supply tube is relatively small), and when the water supply tube (corresponding to a passage IV of the present invention) has a considerable amount of air residing therein, the water outlet may have a water blocking phenomenon so that when the household steaming box is operating, the air resided in the water supply tube (corresponding to a passage IV of the present invention) may not be discharged out of the water supply tube and this leads to inadequate or lack of supply of water to the heating tube. The heating tube may overheat and this presents a potential danger to users.

2. When a valve is provided at the water outlet of the water storing tank, the water outlet is also substantially blocked. This causes a smaller amount of water to flow into the water supply tube. In this case, the heating tube may also overheat and this also presents a potential danger to users.

### SUMMARY OF THE PRESENT INVENTION

The invention is advantageous in that it provides a steam generation device and a household steaming device incorporating the steam generation device. The steam generation device has resolved the problems in conventional arts and is prevented from overheating.

Another advantage of the invention is to provide a steam generation device and a household steaming device incorporating the steam generation device. The steam generation device is energy and water efficient.

According to the present invention, the foregoing and other objects and advantages are attained by providing a steam generation device, which comprises a water IS tank, a steam-water separating device comprising a sealing cover and a base assembly, a guiding valve, at least one heat generating tube, wherein the water tank has a water returning inlet while the base assembly has a water returning tube connected to the water returning inlet, wherein the base assembly has a flat bottom wall and an inclined bottom wall formed at a bottom side of the base assembly at a position near the water returning tube, wherein the steam-water separating device has an air outlet, wherein the water tank further has a water outlet connected to the guiding valve through passage IV, wherein the steam generation device is characterized in that the steam-water separating device and the passage IV are connected with each other.

In the steam generation device, the flat bottom wall has a connecting tube connected to the passage IV through passage I so as to prevent water blocking phenomenon and overheating, and facilitating water reuse.

Passage I and passage IV may be two separate passages, and may be connected to form a single passage so that the overall structure thereof can be simplified.

In the steam generation device, the inclined bottom wall has a connecting tube which is connected to the passage IV through passage III so as to prevent water blocking phenomenon and overheating, and facilitating water reuse.

Passage IV and passage III may be two separate passages, and may be connected to form a single passage so that the overall structure thereof can be simplified.

The air outlet has passage V which is connected to passage II, wherein passage II is connected to passage IV so as to prevent water blocking phenomenon and overheating, and facilitating water reuse because water droplets are collected when the steam generated is cooled down.

Moreover, the water returning inlet has a positioning valve I. The purpose is to when the water tank is fully filled with water, the water will not come out from the water returning inlet.

The steam generation device further comprises a pulling rod extended between the steam-water separating device and the guiding valve. The pulling rod is arranged to support the steam-water separating device so as to reinforce the structural strength of the steam generation device.

The water outlet has a positioning valve II, and a positioning valve III provided corresponding to the positioning valve II. The purpose is to prevent water leakage when the steam generation device has not been disposed into the water tank. The positioning valve III is provided in passage IV so as to prevent water from back-flowing.

The water tank further comprises a returning cover provided at a corresponding sidewall in the water tank which is near the steam-water separating device, wherein the returning cover divides the water tank into two cavities, wherein the water returning inlet is formed in the returning cover, wherein the returning cover has an opening formed at a bottom side thereof at a position corresponding to the water outlet, wherein the opening communicates the two cavities formed by the returning cover, wherein the returning cover further has a slot I formed at an upper portion thereof for communicating the two cavities formed on two sides of the returning cover. Slot I is provided to allow the pressures in two cavities are substantially the same.

As another embodiment, the water tank comprises a partitioning wall provided at a corresponding sidewall in the water tank which is near the steam-water separating device, wherein the partitioning wall divides the water tank into two cavities, and has an opening formed at a bottom end portion thereof to communicate the two cavities, wherein the partitioning wall has a slot II formed at an upper end portion thereof also for communicating the two cavities. Slot II is provided to allow the pressures in two cavities are substantially the same.

The present invention also provides a household steaming device, comprising an outer casing, a steaming chamber, a steam generation device, wherein the steam generation device and the steaming chamber are disposed in the outer casing, wherein when the steam generation device operates, the steaming chamber and the steam generation device are arranged to be connected to form an enclosed structure through passage V. The steam generation device comprises a water tank, a steam-water separating device comprising a sealing cover and a base assembly, a guiding valve, at least one heat generating tube, wherein the water tank has a water returning inlet while the base assembly has a water returning tube connected to the water returning inlet, wherein the base assembly has a flat bottom wall and an inclined bottom wall formed at a bottom side of the base assembly at a position near the water returning tube, wherein the steam-water separating device has an air outlet, wherein the water tank further has a water outlet connected to the guiding valve through passage IV, wherein the steam generation device is characterized in that the steam-water separating device and the passage IV are connected with each other so as to prevent water blocking phenomenon and overheating, and facilitating water reuse.

The water tank further comprises a returning cover provided at a corresponding sidewall in the water tank which is near the steam-water separating device, wherein the returning cover divides the water tank into two cavities, wherein the water returning inlet is formed in the returning cover, wherein the returning cover has an opening formed at a bottom side thereof at a position corresponding to the water outlet, wherein the opening communicates the two cavities formed by the returning cover, wherein the returning cover further has a slot I formed at an upper portion thereof for communicating the two cavities formed on two sides of the returning cover. Slot I is provided to allow the pressures in two cavities are substantially the same.

As another embodiment, the water tank comprises a partitioning wall provided at a corresponding sidewall in the water tank which is near the steam-water separating device, wherein the partitioning wall divides the water tank into two cavities, and has an opening formed at a bottom end portion thereof to communicate the two cavities, wherein the partitioning wall has a slot II formed at an upper end portion thereof also for communicating the two cavities. Slot II is provided to allow the pressures in two cavities are substantially the same.

The water outlet is connected to passage V, which is connected to passage II. Passage II is connected to passage IV. The purpose of this arrangement is to prevent water blocking phenomenon and overheating on the part of the steam generation device. Moreover, the steam is to be cooled to water droplets and is guided to be collected for reuse so as to allow the present invention to be water efficient.

The advantageous effects of the present invention includes: 1. Since the steam-water separating device is connected to passage IV, this prevents the water outlet from experiencing water blocking phenomenon and thus prevents overheating on the part of the heat generating tubes. 2. Since the water tank is divided into two cavities for separating hot water and cold water, this prevents loss of heat and saves a substantial amount of energy. 3. Since passage V is connected to passage II, which is connected to passage III, when the steam enters the steaming chamber, some of the steam is cooled down to form droplets of water. These water droplets are guided to be reuse so that the present invention is water efficient.

### BRIEF DESCRIPTION OF THE DRAWINGS

FIG. 1 is a first diagram of a conventional water-steam separating and steam generation device.

FIG. 2 is a second diagram of the conventional water-steam separating and steam generation device.

FIG. 3 is a schematic diagram of a steam generation device according to a first preferred embodiment of the present invention.

FIG. 4 is a cross sectional view of the steam generation device illustrated in FIG. 3 according to the above first preferred embodiment of the present invention.

FIG. 5 is a schematic diagram of a steam generation device according to a second preferred embodiment of the present invention.

FIG. 6 is a schematic diagram of a steam generation device according to a third preferred embodiment of the present invention.

FIG. 7a is a schematic diagram of a steam-water separating device according to the above first preferred embodiment of the present invention.

FIG. 7b is a schematic diagram of a base assembly according to the above first preferred embodiment of the present invention.

FIG. 7c is a schematic diagram of a base assembly according to the above second preferred embodiment of the present invention.

FIG. 7d is a schematic diagram of a base assembly according to the above third preferred embodiment of the present invention.

FIG. 8a is a sectional side view of a water tank according to a fifth preferred embodiment of the present invention.

FIG. 8b is a sectional side view of a water tank according to a sixth preferred embodiment of the present invention.

FIG. 9 is schematic diagram of a household steaming device according to a preferred embodiment of the present invention.

FIG. 10 is a schematic diagram of a steaming chamber and a steam generation device according to the above preferred embodiment of the present invention.

Numerical reference in the drawings:

1—water tank, 11—returning cover, 110—slot I, 111—partitioning wall, 1110—slot II, 2—positioning valve I, 3—water returning inlet, 4—steam-water separating device, 41—sealing cover, 410—blocking panel I, 411—guiding curve, 412—cover body, 4121—left cover chamber, 4122—right cover chamber, 42—base assembly, 420—flat bottom wall, 421—returning tube, 422—connecting tube, 423—inclined bottom wall, 424—connecting base, 425—blocking panel II, 4203—base cavity, 426—air outlet, 5—guiding valve, 6—heat generating tube, 7—passage I, 8—positioning valve III, 9—water outlet, 10—positioning valve II, 12—passage V, 13—passage II, 14—passage III, 15—passage IV, 16—pulling rod, 17—steam generation device, 18—steaming chamber, 19—outer casing.

### DETAILED DESCRIPTION OF THE PREFERRED EMBODIMENT

The present invention is further described with the following embodiments and the accompanying drawings to illustrate the technical problems, the technical solutions and the advantageous effect of the present invention.

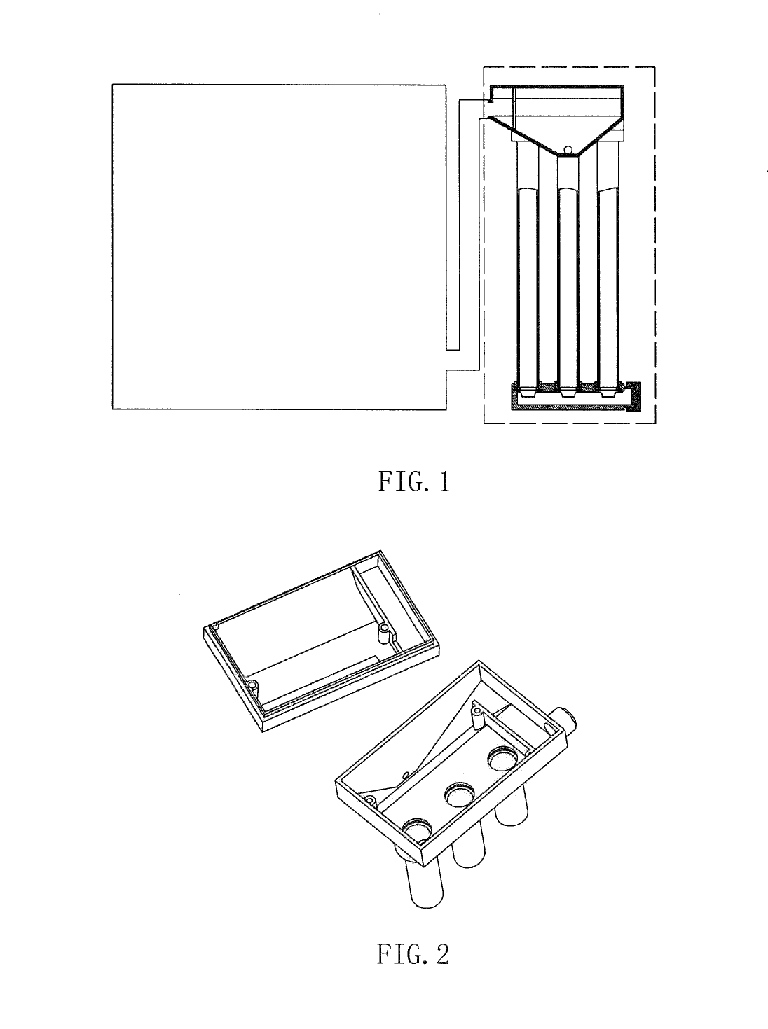

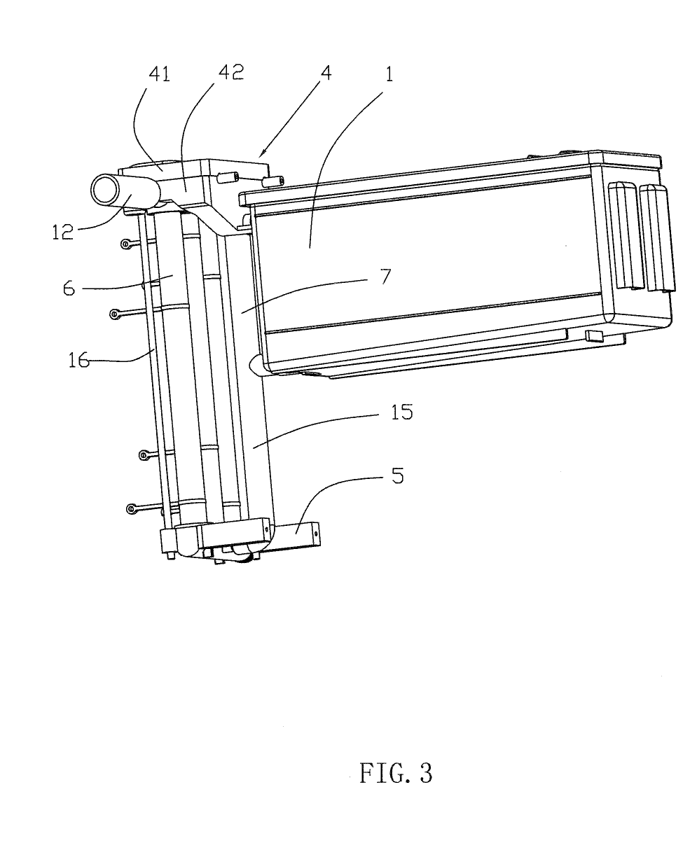

Referring to FIG. 1 to FIG. 2 of the drawings, they illustrate the invention filed in China by the inventor of this application, wherein the filing date is Apr. 13, 2010, and an application number of 201010150829.1 [title: water-steam separating and steam generation device]. The present invention improves upon the above-mentioned invention illustrated in the Chinese patent application. The objective of the present invention is to tackle overheating problem on the part of a heat generating tube 6 of a steam generation device when a water outlet 9 is substantially blocked so that water may not properly flow into the heat generating tube 6.

In order to simplify the preferred embodiment of the present invention, the steam generation device is provided in a household steaming device so that the detailed description presented below will focus on the household steaming device.

### Embodiment 1

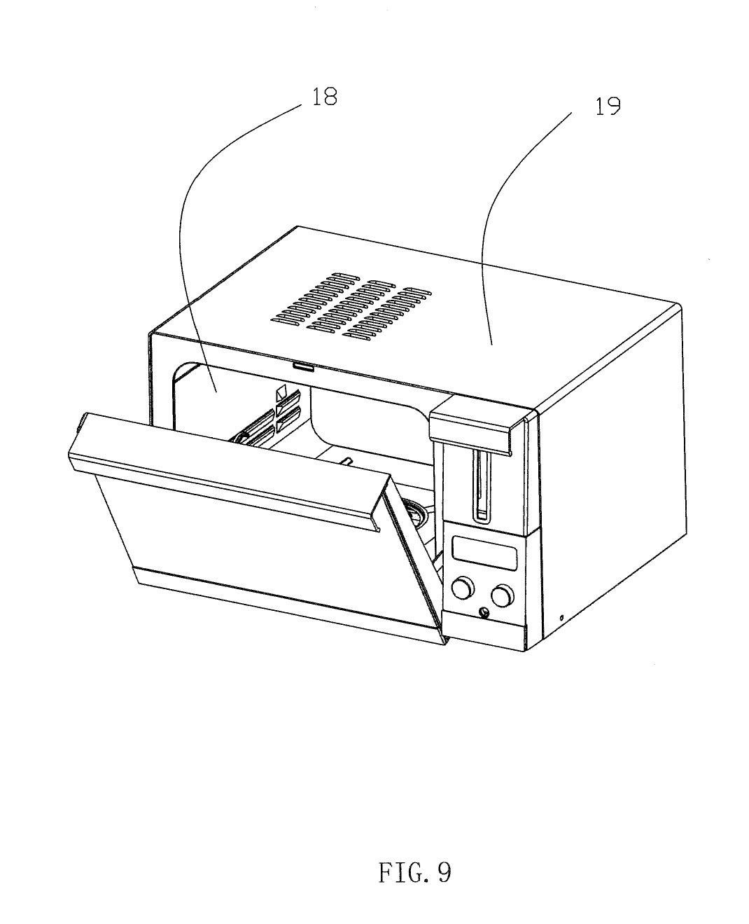

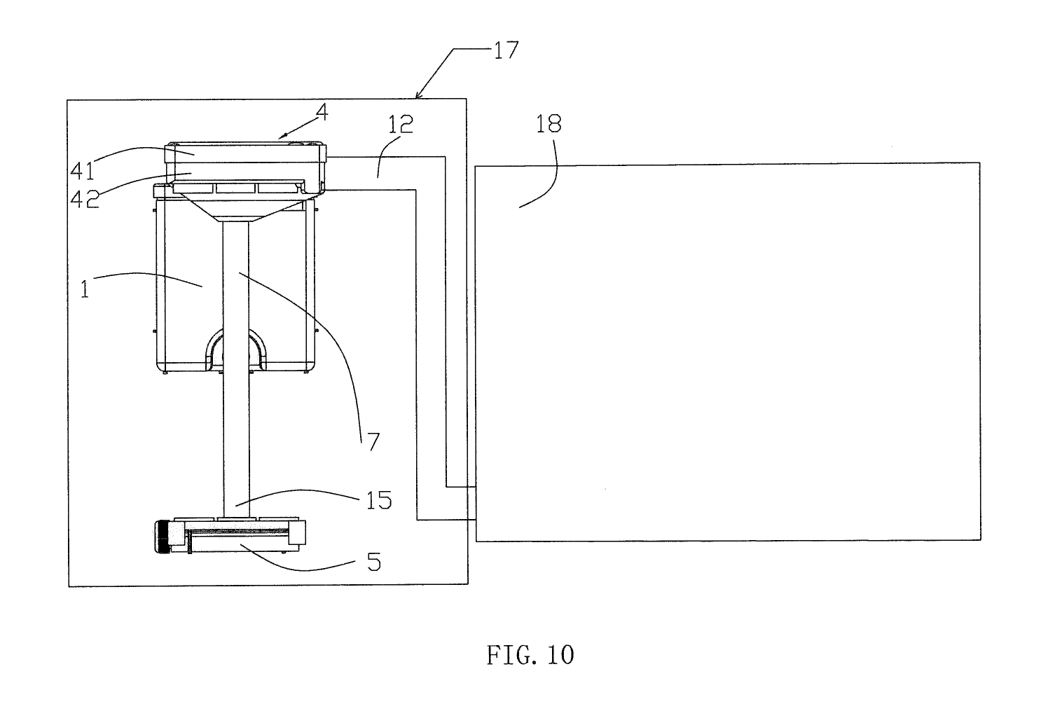

Referring to FIG. 9 to FIG. 10 of the drawings, the household steaming device comprises an outer casing 19, a steaming chamber 18, a steam generation device 17, wherein the steam generation device 17 is disposed in the outer casing 19. When the steam generation device 17 is operating (i.e. when a door of the steaming chamber 18 is closed), the steaming chamber 18 and the steam generation device 17 is arranged to be connected by a passage V 12 to form an enclosed structure.

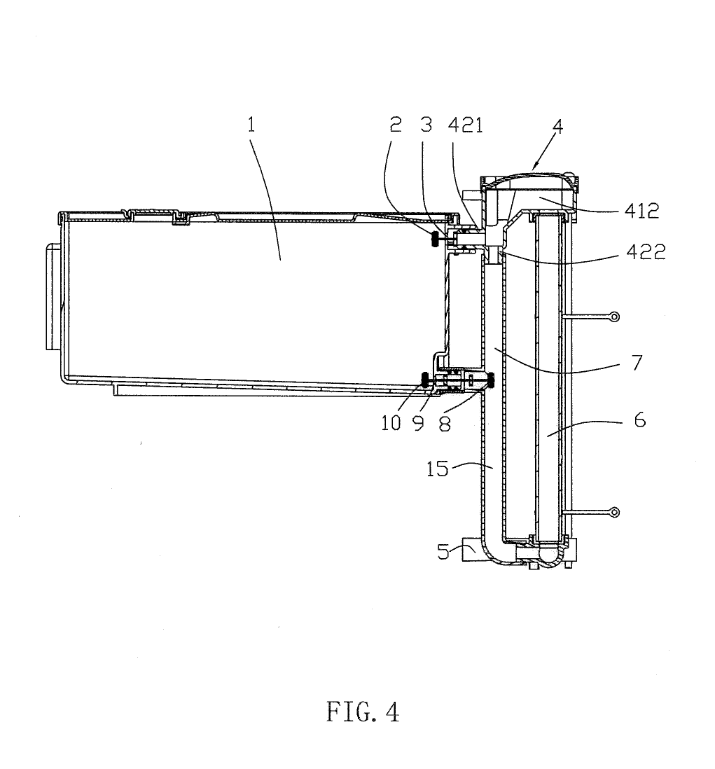

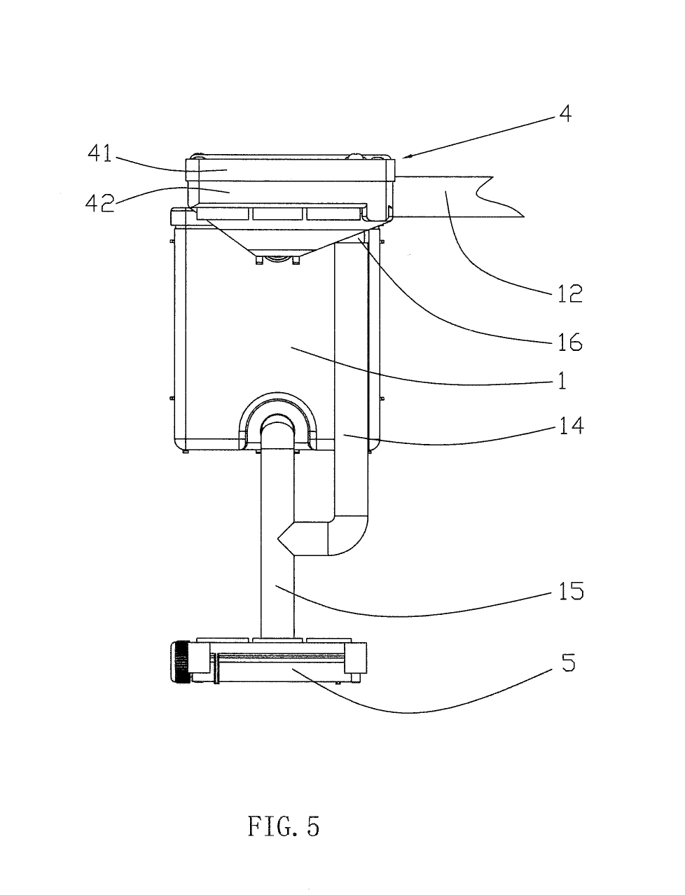

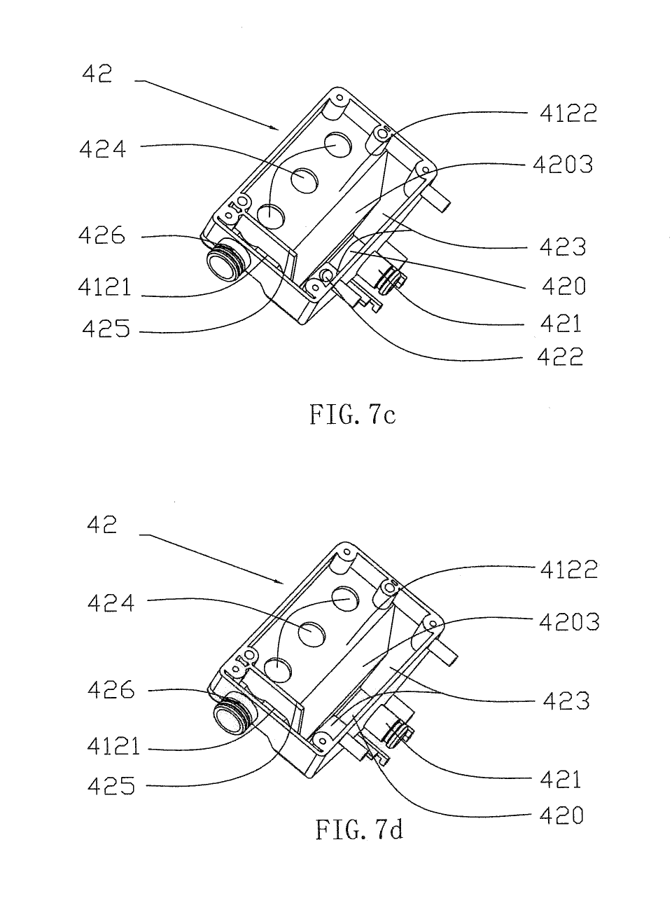

Referring to FIG. 3 of the drawings, the steam generation device 17 comprises a water tank 1, a steam-water separating device 4 comprising a sealing cover 41 and a base 42, a guiding valve 5, and a plurality of heat generating tubes 6. Referring to FIG. 4 of the drawings, the sealing cover 41 is provided on top of the base assembly 42, and defines a cover body 412. Referring to FIG. 7a of the drawings, the sealing cover 41 comprises a blocking panel I 410, and a guiding curve 411. Referring to FIG. 7b of the drawings, the base assembly 42 comprises a returning tube 421, a connecting tube 422, a plurality of connecting bases 424, a blocking panel II 425, and an air outlet 426. The base assembly 42 has a base cavity 4203 formed at a bottom side thereof, wherein the base cavity 4203 and the guiding curve 411 are formed in a side-by-side manner, and the base cavity 4203 is defined by a flat bottom wall 420 and a inclined bottom wall 423. The flat bottom wall 420 and the inclined bottom wall 423 are provided adjacent to the returning tube 421, which is positioned at an outer sidewall of the base assembly 42 and corresponding to the flat bottom wall 420 of the base cavity 4203. The blocking panel I 410 and the blocking panel II 425 are spacedly positioned in the cover body 412 to divide the chamber cavity 412 into a left cover chamber 4121 and a right cover chamber 4122, wherein the air outlet 426 and the connecting base 424 are communicated with the left cover chamber 4121 and the right cover chamber 4122 respectively. Each of the blocking panel I 410 and the blocking panel II 425 has an indention formed at a distal thereof respectively, wherein the connecting base 424 and the air outlet 426 are connected with each other through these indentions. The connecting tube 422 is provided on the flat bottom wall 420.

The steam generation device 17 further comprises a pulling rod 16 provided between the steam-water separating device 4 and the guiding valve 5 for connecting the steam-water separating device 4 and the guiding valve 5 to form an integral structure. Moreover, the pulling rod 16 also supports the steam-water separating device 4 so as to prevent the corresponding heat generating tube 6 from being pressed for prolong a general life span of the steam generation device 17. The heat generating tubes 6 extend between the connecting base 424 and the guiding valve 5. The air outlet 426 is connected to the steaming chamber 18 through the passage V 12. The water tank 1 has a water returning inlet 3, and a water outlet 9 provided on an upper end portion and a lower end portion thereof respectively, wherein the water returning inlet 3 and the water outlet 9 are formed at a side portion of the water tank 1 which is corresponding to the steam-water separating device 4. The steam generation device 17 further comprises a positioning valve I 2 provided at the water returning inlet 3, and a resilient element provided on the positioning valve I 2. On the other hand, the steam generation device 17 further comprises a positioning valve II 10 provided at the water outlet 9, and a positioning valve III 8 provided on passage IV 15 at a position corresponding to the positioning valve II 10. Each of the positioning valve II 10 and the positioning valve III 8 is equipped with a resilient element. The water returning inlet 3 communicates with the returning tube 421.

The water outlet 9 and the guiding valve 5 are connected to the passage IV 15, which also connects the connecting tube 422 and a passage I 7 (the passage I 7 and the passage IV 15 may form an integral passage). The intersection between the passage IV 15 and the passage I 7 is preferably positioned adjacent to the water outlet 9.

The working principle of the household steaming device is as follows: when the water tank 1 is filled with a predetermined amount of water, it can be activated to a working mode. The positioning valve I 2, the positioning valve II 10, and the positioning valve III 8 are activated to keep the returning inlet 3 and the water outlet 9 open through the resilient ability of the resilient member of the positioning valves I, II, III 2, 10, 8. At this time, the water stored in the water tank 1 is arranged to flow out of the water tank 1 through the water outlet 9. The water flowing out through the water outlet 9 is arranged to flow through the passage IV 15 and the guiding valve 5 and into the heat generating tubes 6. The heat generating tubes 6 are then electrically connected to a power source and starting generating heat for a predetermined period of time. The heat generating tubes 6 are arranged to heat up the water flowing thereinto and generate steam. The steam is then guided to flow into the corresponding connecting base 424 and enters the right cover chamber 4122 first and then to the left cover chamber 4121. The steam entering the left cover chamber 4121 is arranged to flow through the air outlet 426 and enters the steaming chamber 18 through the passage V 12. The hot water heated up by the heat generating tubes 6 is arranged to flow into the connecting base 424 and then to the right cover chamber 4122. Some of the hot water is arranged to flow through the connecting tube 422, passage I 7 and passage IV 5 and finally reach the guiding valve 5. The remaining hot water in the heat generating tubes 6 is arranged to flow through the returning tube 421 and then flow back to the water tank 1 through the water returning inlet 3.

Since the steam-water separating device 4 accomplishes the connection of passage I 7 and passage IV 15, the water outlet 9 is prevented from being blocked by residual air so that water can freely and effectively flow into the heat generating tubes 6 so as to prevent overheating thereof. This also speeds up the return of water back into the water tank 1 for the steam-water separating device 4.

When the water stored in the water tank 1 is inadequate or when there is simply no water stored in the water tank 1, a water level detector will issue a warning signal and cut off the electric supply to the steam generation device 17 so as to turn off the household steaming device.

### Embodiment 2

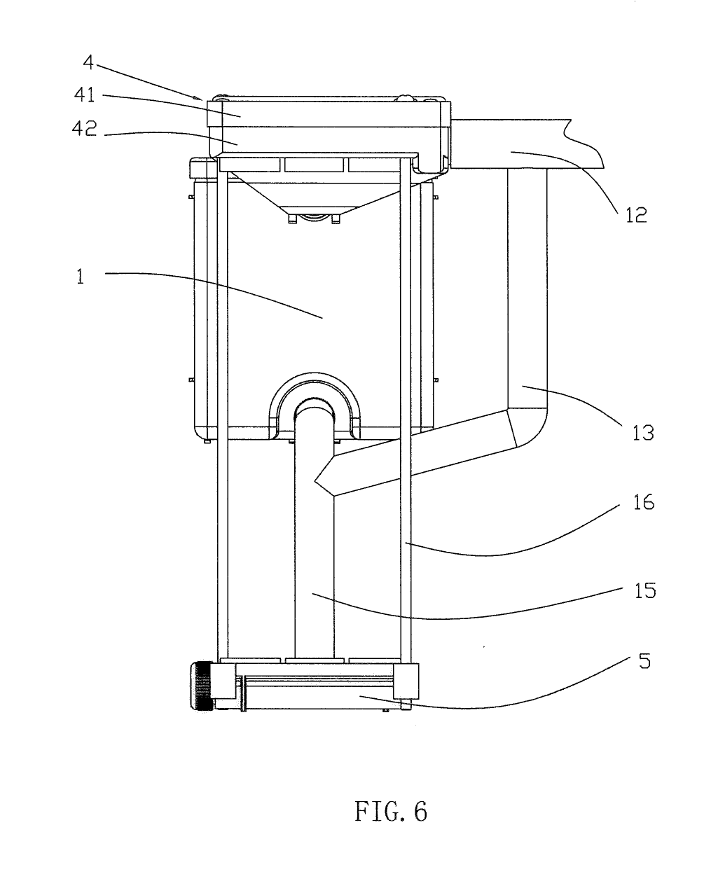

Referring to FIG. 5 and FIG. 7c of the drawings, the main difference between the second and the first embodiment described above is that the connecting tube 422 is provided on the inclined bottom wall 423. The connecting tube 422 is connected to passage IV 15 and passage III 14 (Note: passage IV 15 and passage III 14 may also be connected to form an integral passage). The intersection between the passage IV 15 and the passage III 14 is preferably positioned adjacent to the water outlet 9.

The difference in working principles between the first embodiment and the second embodiment is that when the heat generating tube 6 has heated up the water flowing therein, a predetermined amount of steam is generated. The steam is then arranged to flow in to the corresponding connecting base 424, the right cover chamber 4122 and then to the left cover chamber 4121. The steam is then arranged to flow into the air outlet 426 and enters the steaming chamber 18 through passage V 12. On the other hand, a predetermined hot water is also generated in the heat generating tubes 6, the hot water is guided to flow into the connecting base 424 and then into the right cover chamber 4122. From there, some of the hot water will flow through passage III 14 and passage IV 15 and reach the guiding valve 5. The remaining hot water will flow through the returning tube 421 and then flow back to the water tank 1 through the water returning inlet 3.

Since the steam-water separating device 4 accomplishes the connection of passage III 14 and passage IV 15, the water outlet 9 is prevented from being blocked by residual air so that water can freely and effectively flow into the heat generating tubes 6 so as to prevent overheating thereof This also speeds up the return of water back into the water tank 1 for the steam-water separating device 4.

### Embodiment 3

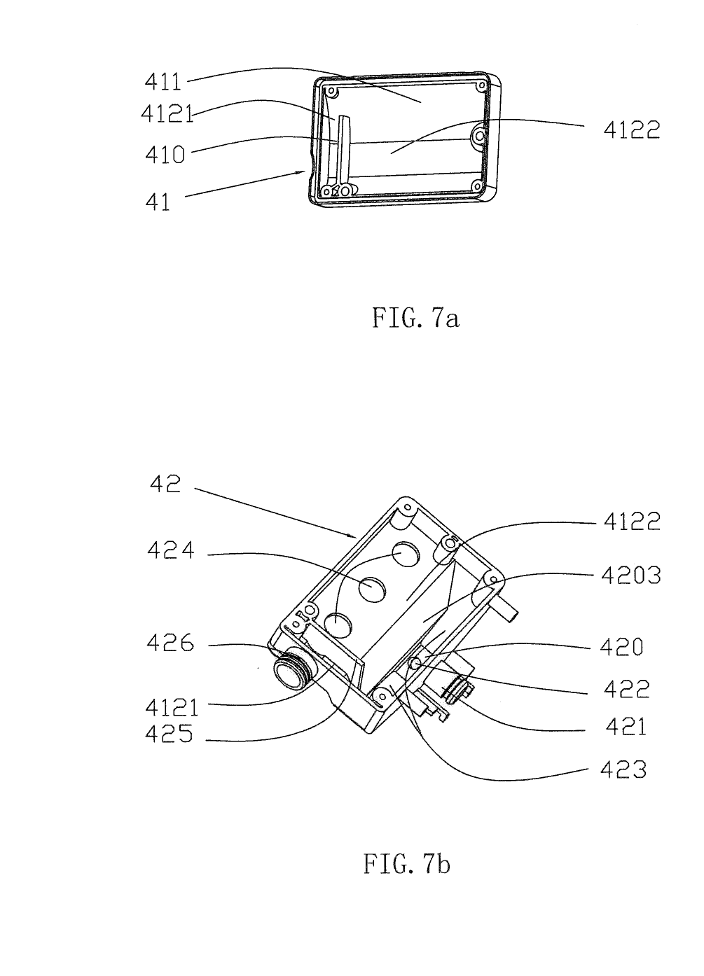

Referring to FIG. 6 and FIG. 7d of the drawings, the third preferred embodiment is similar to the first embodiment and the second embodiment described above, but the main difference between the third embodiment and the first/second embodiment described above is that the connecting tube 422 is absent in the base assembly 42. Passage V 12 is connected to a passage II 13 (Note: passage II 13 and passage V 12 may also be connected to form an integral passage), which is connected to passage IV 15 (Note: passage II 13 and passage IV 15 may also be connected to form an integral passage). Passage II 13 may be positioned anywhere with respect to passage V 12, but it should be positioned near the steaming chamber 18.

The working principles of the third embodiment is similar to the first embodiment and the second embodiment, the main difference being when the heat generating tube 6 has heated up the water flowing therein, a predetermined amount of steam is generated. The steam is then arranged to flow in to the corresponding connecting base 424, the right cover chamber 4122 and then to the left cover chamber 4121. The steam is then arranged to flow into the air outlet 426 and enters the steaming chamber 18 through passage V 12. When the steam flows through passage V 12, some of the steam is cooled down to form water droplets. These water droplets are guided to flow into passage II 13 and passage IV 15 and eventually reach the guiding valve 5. On the other hand, a predetermined hot water is also generated in the heat generating tubes 6, the hot water is guided to flow into the connecting base 424 and then into the right cover chamber 4122. The hot water is then arranged flow through the returning tube 421 and then flow back to the water tank 1 through the water returning inlet 3.

In this embodiment, since the steam-water separating device 4 accomplishes the connection of passage II 13 and passage IV 15, the water outlet 9 is prevented from being blocked by residual air so that water can freely and effectively flow into the heat generating tubes 6 so as to prevent overheating thereof. Because of passage II 13, the steam entering the steaming chamber 18 is more saturated, and the water droplets are collected and guided to flow back to the guiding valve 5 and this saves a considerable amount of water when the household steaming device is operating.

### Embodiment 4

Compared to embodiment 1 to embodiment 3 mentioned above, the main difference of embodiment 4 of the present invention is that embodiment 4 is a combination of embodiment 1 and embodiment 3.In this embodiment, the connecting tube 422 is provided on the flat bottom wall 420 and is connected to passage IV 15 and passage I 7. Moreover, passage V 12 is connected to passage II 13 (Note that passage IV 15, passage 17 and passage III 3 may be connected to form an integral passage). The present embodiment may also be a combination of embodiment 2 and embodiment 3. In such a case, the connecting tube 422 is provided on the inclined bottom wall 423, while the connecting tube 422 is connected to passage IV 15 and passage III 14. Passage V 12 is also connected to passage II 13 (Note that passage IV 15, passage III 14 and passage II 13 may also be connected to form an integral passage).

The working principles of the fourth embodiment is similar to the first embodiment to third embodiment mentioned above, but the main difference is that when the heat generating tube 6 has heated up the water flowing therein, a predetermined amount of steam is generated. The steam is then arranged to flow in to the corresponding connecting base 424, the right cover chamber 4122 and then to the left cover chamber 4121. The steam is then arranged to flow into the air outlet 426 and enters the steaming chamber 18 through passage V 12. When the steam flows through passage V 12, some of the steam is cooled down to form water droplets. These water droplets are guided to flow into passage II 13 and passage IV 15 and eventually reach the guiding valve 5. On the other hand, a predetermined hot water is also generated in the heat generating tubes 6, the hot water is guided to flow into the connecting base 424 and then into the right cover chamber 4122. A certain amount of hot water is arranged to pass through the connecting tube 422 and then to passage I 7 (the combination of embodiment 1 and embodiment 3) or passage III 14 (the combination of embodiment 2 and embodiment 3) and passage IV 15 and eventually reach the guiding valve 5. Some of the hot water is then arranged flow through the returning tube 421 and then flow back to the water tank 1 through the water returning inlet 3.

In this embodiment, since the steam-water separating device 4 is accomplishes the connection of passage I 7 (the combination of embodiment 1 and embodiment 3) or to passage III 14 (the combination of embodiment 2 and embodiment 3) with passage II 13 and passage IV 15, the water outlet 9 is prevented from being blocked by residual air so that water can freely and effectively flow into the heat generating tubes 6 so as to prevent overheating thereof Because of passage II 13, the steam entering the steaming chamber 18 is more saturated, and the water droplets are collected and guided to flow back to the guiding valve 5 and this saves a considerable amount of water when the household steaming device is operating.

### Embodiment 5

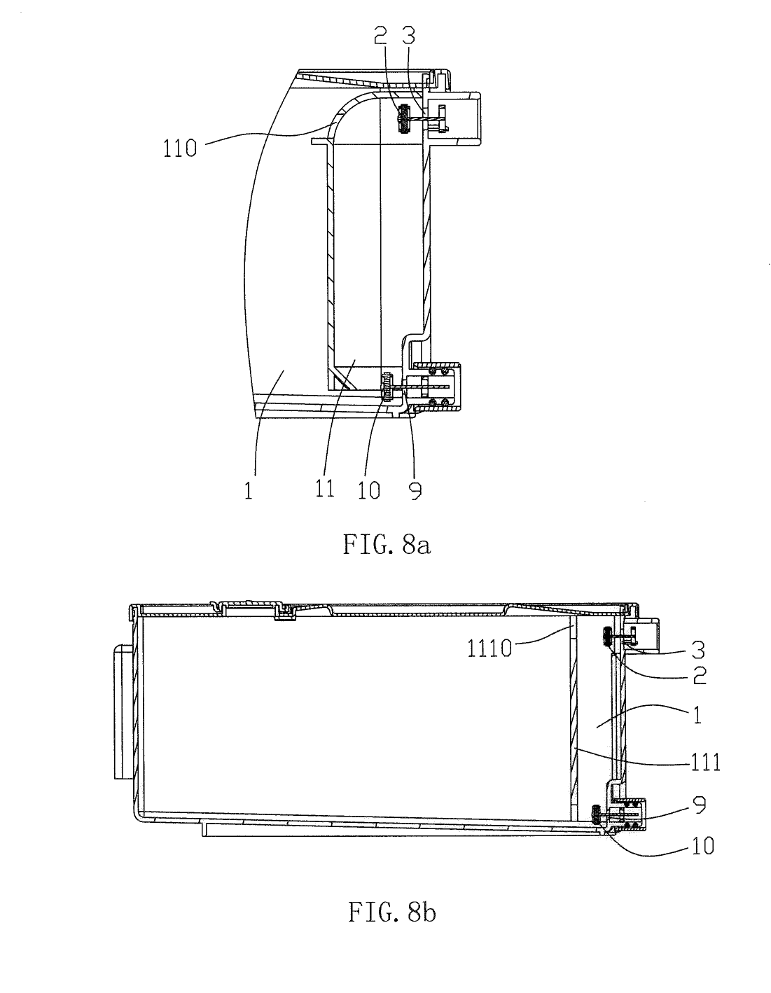

Referring to FIG. 8a of the drawings, the difference between the present embodiment and embodiments 1 through 4 mentioned above is that the water tank 1 further comprises a returning cover 11 provided at a corresponding sidewall in the water tank 1 which is near the steam-water separating device 4. The returning cover 11 divides the water tank 1 into two cavities, wherein the water returning inlet 3 is formed in the returning cover 11. The returning cover 11 has an opening formed at a bottom side thereof at a position corresponding to the water outlet 9, wherein the opening is communicates the two cavities formed by the returning cover 11. Moreover, the returning cover 11 further has a slot I 110 formed at an upper portion thereof for communicating the two cavities formed on two sides of the returning cover 11.

The working principles of the fifth embodiment is similar to the first embodiment to fourth embodiments mentioned above, but the main difference is that the hot water generating in the heat generating tube 6 and flowing through the returning tube 421 is arranged to enter the corresponding cavity partitioned by the returning cover 11 so as to be separated from the remaining and relatively cool water stored in the water tank 1 for minimizing heat loss from the hot water and saving energy. The slot I 110 makes the pressure of the two cavities formed by the returning cover 11 to be substantially the same, so as to prevent excessive pressure being developed in the steam-water separating device 4 and overheating thereof.

### Embodiment 6

Referring to FIG. 8b of the drawings, the difference between the present embodiment and the fifth embodiment mentioned above is that the returning cover 11 is replaced by a partitioning wall 111. Again, the partitioning wall 111 divides the water tank 1 into two cavities, and has an opening formed at a bottom end portion thereof to communicate the two cavities. Moreover, the partitioning wall 111 has a slot II 1110 formed at an upper end portion thereof also for communicating the two cavities.

The difference in working principles between the present embodiment and the fifth embodiment is that the hot water generating in the heat generating tube 6 and flowing through the returning tube 421 is arranged to enter the corresponding cavity partitioned by the partitioning wall 111 so as to be separated from the remaining and relatively cool water stored in the water tank 1 for minimizing heat loss from the hot water and saving energy. The slot II 1110 makes the pressure of the two cavities formed by the partitioning wall 111 to be substantially the same, so as to prevent excessive pressure being developed in the steam-water separating device 4 and overheating thereof.

The number of the heat generating tubes 6 may be varied depending on application circumstances. Moreover, each of the heat generating tubes 6 can be embodied as quartz tubes, electric heating tubes, superconducting heating tubes, and can be straight tubes, or curved tubes.

When the steam-water separating device 4 is big enough, that is when the steam passing through passage V 12 is sufficiently saturated, passage II 13 can be absent from this sixth embodiment.

When a diameter of the water outlet 9 is large enough so that the water blocking phenomenon and overheating problem do not exist, passage 17, passage III 14 and passage II 13 can also be absent from this sixth embodiment.

When there is no need to fill a full tank of water in the water tank 1, the water returning inlet 3 does not need to have the positioning valve I 2, and when the water tank 1 does not need to be taken out for refilling water, the water outlet 9 does not need to have the positioning valve II 10 and the positioning valve III 8.

What is claimed is:

1. A steam generation device, which comprises a water tank (1), a steam-water separating device (4) comprising a sealing cover (41) and a base assembly (42), a guiding valve (5), at least one heat generating tube (6), wherein said water tank (1) has a water returning inlet (3) while said base assembly has a water returning tube (421) connected to said water returning inlet (3), wherein said base assembly (42) has a flat bottom wall (420) and an inclined bottom wall (423) formed at a bottom side of said base assembly (42) at a position near said water returning tube (421), wherein said steam-water separating device (4) has an air outlet (426), wherein said water tank (1) further has a water outlet (9) connected to said guiding valve through passage IV (15), wherein said steam generation device is characterized in that said steam-water separating device (4) and said passage IV (15) are connected with each other.

2. The steam generation device, as recited in claim 1, wherein said flat bottom wall (420) has a connecting tube (422) connected to said passage IV (15) through passage I (7).

3. The steam generation device, as recited in claim 1, wherein said inclined bottom wall (423) has a connecting tube (422) which is connected to said passage IV (15) through passage III (14).

4. The steam generation device, as recited in claim 1, wherein said air outlet (426) has passage V (12) which is connected to passage II (13), wherein said passage II (13) is connected to said passage IV (15).

5. The steam generation device, as recited in claim 1, wherein said water returning inlet (3) has a positioning valve I (2).

6. The steam generation device, as recited in claim 1, further comprising a pulling rod (16) extended between said steam-water separating device (4) and said guiding valve (5).

7. The steam generation device, as recited in claim 6, wherein said water outlet (9) has a positioning valve II (10), and a positioning valve III (8) provided corresponding to said positioning valve II (10).

8. The steam generation device, as recited in claim 7, wherein said water tank (1) further comprises a returning cover (11) provided at a corresponding sidewall in said water tank (1) which is near said steam-water separating device (4), wherein said returning cover (11) divides said water tank (1) into two cavities, wherein said water returning inlet (3) is formed in said returning cover (11), said returning cover (11) has an opening formed at a bottom side thereof at a position corresponding to said water outlet (9), wherein said opening communicates said two cavities formed by said returning cover (11), wherein said returning cover (11) further has a slot I (110) formed at an upper portion thereof for communicating said two cavities formed on two sides of said returning cover (11).

9. The steam generation device, as recited in claim 7, wherein said water tank (1) further comprises a partitioning wall (111) provided at a corresponding sidewall in said water tank (1) which is near said steam-water separating device (4), wherein said partitioning wall (111) divides said water tank (1) into two cavities, and has an opening formed at a bottom end portion thereof to communicate said two cavities, wherein said partitioning wall (111) has a slot II (1110) formed at an upper end portion thereof also for communicating said two cavities.

10. A household steaming device, comprising an outer casing (19), a steaming chamber (18), a steam generation device (17), wherein said steam generation device (17) and said steaming chamber (18) are disposed in said outer casing (19), wherein when said steam generation device (17) operates, said steaming chamber (18) and said steam generation device (17) are arranged to be connected to form an enclosed structure, wherein said household steaming device is characterized in that said steam generation device (17) is recited in claim 9.
